(19) United States
(12) Patent Application Publication
(10) Pub. No.: US 2023/0369809 A1
(43) Pub. Date: Nov. 16, 2023

(54) Connection Terminal and Electrical Connector

(71) Applicants: Tyco Electronics AMP Guangdong Ltd, Foshan City (CN); TE Connectivity Solutions GmbH, Schaffhausen (CH); Tyco Electronics (Shanghai) Co., Ltd., Shanghai (CN)

(72) Inventors: Liang (Vincent) Huang, Shanghai (CN); Eric David Briant, Middletown, PA (US); Yiyang LU, Foshan (CN)

(73) Assignees: Tyco Electronics AMP Guangdong Ltd, Foshan City (CN); TE Connectivity Solutions GmbH, Schaffhausen (CH); Tyco Electronics (Shanghai) Co., Ltd., Shanghai (CN)

(21) Appl. No.: 18/318,054

(22) Filed: May 16, 2023

(30) Foreign Application Priority Data
May 16, 2022 (CN) 202210585129.8

(51) Int. Cl. H01R 13/6471; H01R 13/516; H01R 12/57

(52) U.S. Cl. CPC H01R 13/6471; H01R 13/516; H01R 12/57

(57) ABSTRACT

A connector connection terminal for an electrical connector includes a main body part, a soldering leg and a transition section. The main body part is adapted to be installed inside an insulating housing of the electrical connector. The soldering leg is adapted to be soldered onto a circuit board so as to electrically connect the connection terminal to the circuit board. The soldering leg and the main body part have different widths. The transition section extends from the main body part to the soldering leg such that a width of at least a portion of the transition section is gradually changed.

### CROSS-REFERENCE TO RELATED APPLICATION

This application claims the benefit of Chinese Patent Application No. CN202210585129.8 filed on May 16, 2022, in the China National Intellectual Property Administration, the whole disclosure of which is incorporated herein by reference.

### FIELD OF THE INVENTION

The present invention relates to a connection terminal, and more particularly, to a connection terminal capable of improving signal integrity (SI) performance and an electrical connector including the connection terminal, which is applicable to different application requirements, such as high-speed data transmission applications.

### BACKGROUND

As data rates of high-speed links increase continually, e.g., up to 224 Gbps, it requires high requirements for a performance of a connector. It is very important to improve the signal integrity (SI) performance by adjusting structures of both the terminals and the housing of the connector. In particular, the soldering legs of terminals in a high-speed input and output connector are often narrow, and the terminals are generally wide in a main body portion thereof. Thus, there is a transition portion from the wide main body portion to the narrow soldering leg of each terminal. In addition, in order to facilitate soldering the terminal on a circuit board, there is often a bent portion from the soldering leg to the main body portion. In a conventional connector, a width of the terminal is constant at the bent portion, such as maintaining the same width as the soldering leg, and a width transition section is outside of the bent portion. From the perspective of SI, the narrow terminal will lead to an increase in impedance and occurrence of serious impedance mismatching. It is critical to optimize the SI performance while ensuring the accuracy and reliability of machining the terminal.

### SUMMARY

A connection terminal for an electrical connector according to an embodiment of the present disclosure includes a main body part, a soldering leg and a transition section. The main body part is adapted to be installed inside an insulating housing of the electrical connector. The soldering leg is adapted to be soldered onto a circuit board so as to electrically connect the connection terminal to the circuit board. The soldering leg and the main body part have different widths. The transition section extends from the main body part to the soldering leg such that a width of at least a portion of the transition section is gradually changed.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a perspective view schematically showing an electrical connector according to an exemplary embodiment of the present disclosure;

FIG. 2 is a partially enlarged view schematically showing a structure of the electrical connector, with an insulating housing of the electrical connector being partially removed to expose a connection terminal, according to an exemplary embodiment of the present disclosure;

FIG. 3 is a partially enlarged view schematically showing a structure of a connection terminal of an electrical connector according to an exemplary embodiment of the present disclosure;

FIG. 4 is a top view schematically showing a structure of a connection terminal according to an exemplary embodiment of the present disclosure;

FIG. 5 is a side view schematically showing a structure of a connection terminal according to an exemplary embodiment of the present disclosure; and

FIG. 6 is a schematic graph showing the signal integrity (SI) performance of a conventional connection terminal and a connection terminal according to an exemplary embodiment of the present disclosure.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

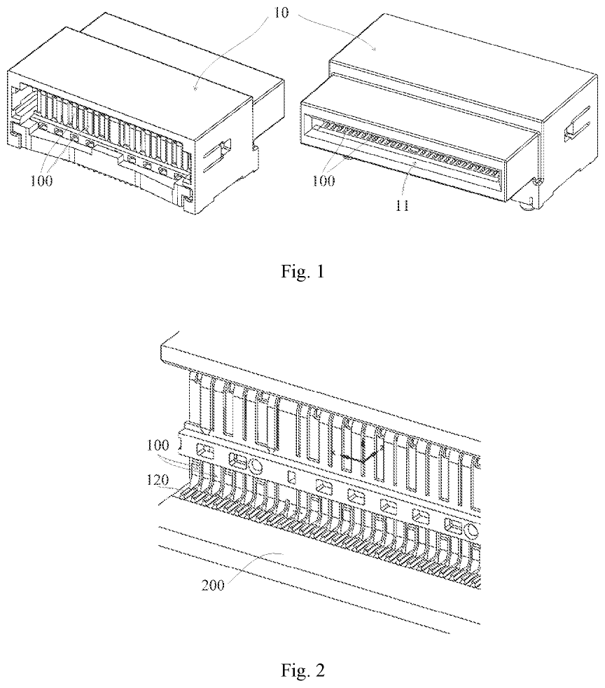

FIG. 1 schematically shows an electrical connector according to an exemplary embodiment of the present disclosure. The electrical connector includes an insulating housing 10 made of, for example plastic, and a connection terminal 100 provided in the housing 10 for establishing a signal/electrical connection between a circuit board of, for example, a piece of electric equipment (not shown) and a mating connector. The connection terminal of the electrical connector is soldered on or to the circuit board by a soldering leg and connected to the mating connector by a mating port 11.

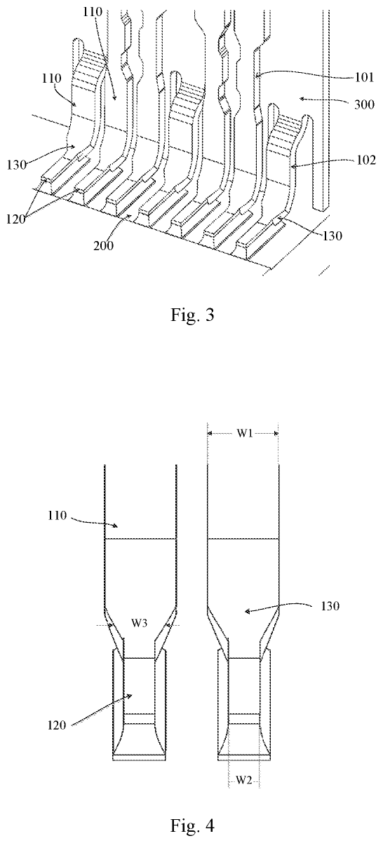

As shown in FIGS. 1-3, a plurality of connection terminals 100 may be installed inside the insulating housing 10, which may be arranged at intervals in a width direction (e.g., X direction as shown in FIG. 2) of the electrical connector or the connection terminals. The plurality of connection terminals 100 may include a signal terminal 101, a ground terminal 102 and/or a power supply terminal, which may be arranged at intervals in the width direction of the terminals. For example, as shown in FIG. 3, one or more signal terminals 101 are arranged between two adjacent ground terminals 102, or one or more ground terminals are arranged between adjacent signal terminals to achieve signal shielding effect and reduce signal interference.

In an exemplary embodiment according to the present disclosure, at least one connection terminal 100 of the electrical connector is configured with a structure that can improve the signal integrity (SI) performance, so that the electrical connector can be adapted to data transmission over high-speed links, such as a data transmission rate up to 224 Gbps, to be used as a high-speed input/output connector. It should be understood that either the signal terminal or the ground terminal may be configured in this way to improve the SI performance.

In an exemplary embodiment, as shown in FIGS. 2-5, the connection terminal 100 includes a main body part 110, which is installed inside the insulating housing 10 of the electrical connector and has one end to be in electrical contact with the mating connector, and a soldering leg 120. The soldering leg 120 is soldered on the circuit board 200, for example on a soldering pad on the circuit board, to achieve the installation and electrical connection of the electrical connector to the circuit board. Generally, the soldering leg 120 and the main body part 110 have different widths. Specifically, the connection terminal 100 is wider at the main body part 110, and the soldering leg 120 is narrower to be adapted to a limited soldering space on the circuit board. For example, as shown in FIG. 4, the main body part has a first width W1, and the soldering leg 120 has a second width W2 less than the first width W1. In some applications, as an example, the first width W1 may be 0.4 mm, and the second width W2 may be 0.18 mm.

As shown in the figures, the connection terminal 100 further includes a transition section 130 extending from the main body part 110 to the soldering leg 120. According to an embodiment of the present disclosure, a width of at least a portion of the transition section 130 is gradually changed in a length direction of the transition section, e.g., gradually decreasing from the first width W1 of the main body part 110 to the second width W2 of the soldering leg 120. In this way, a long and narrow portion found in prior art terminals is avoided in the transition section of the connection terminal, thereby preventing the local impedance from being increased.

As shown in FIG. 6, a portion (a) shows an impedance curve of a conventional connection terminal. As its transition section is narrow, a serious impedance mismatch occurs. A portion (b) shows an impedance curve of the connection terminal according to an embodiment of the present disclosure. As a result of the gradually changing width in the transition section, the significant impedance mismatch of the terminal is avoided, and the return loss and insertion loss are correspondingly improved. This improves the SI performance of the connector to a level suitable for high-rate data transmission applications.

As an example, the width of the at least a portion of the transition section 130 may be changed continuously and uniformly, or changed substantially linearly, or changed continuously in a segmented mode, or changed in a stepped manner, from the first width W1 to the second width W2. Preferably, the entire transition section is bent and has a gradually changing width to further optimize the SI performance. In other examples, a portion of the transition section (such as a middle portion) is bent and its width is gradually changed. Portions connected with the main body part and the soldering leg have the same or similar width as the main body part and the soldering leg, respectively. Alternatively, the transition section includes a first portion having the same width as the main body part and a second portion extending in such a way that its width is gradually changed from the first portion to the soldering leg, but the present disclosure is not limited to this.

In the embodiments shown, at least one portion of the transition section 130, such as a portion with the gradually changed width, is a bent section to change an orientation of the connection terminal 100 (i.e., from an orientation of the main body part 110 to an orientation of the soldering leg 120) so as to be soldered on the circuit board 200. Because the gradually changing width of the transition section occurs in the bent section, a segment with the changed width can be longer, rather than a sudden change from narrow to wide in a small distance, thus a bending radius of the transition section increases accordingly. A large bending radius may reduce the influence of the change of the terminal's width on the final molding of the terminal. This avoids the risk of tearing of, or creating raw edges on, the terminal, so that the connection terminal can be machined accurately and reliably from a base material, while optimizing its SI performance.

As an example, as shown in FIGS. 2, 3 and 5, the main body part 110 extends at least partially substantially in a first direction (e.g., Y direction or vertical direction as shown in the figures) or is straight, and the soldering leg 120 extends or is straight in a second direction (e.g., Z direction or horizontal direction as shown in the figures) perpendicular to the first direction. The first direction and the second direction may be perpendicular to the width direction of the connection terminal. The bent section of the transition section 130 is bent from a portion extending in the first direction to a portion extending in the second direction. As a result, the connection terminal 100 is at least partially transformed from extending in the first direction to extending in the second direction to facilitate the arrangement and installation of the connection terminal. However, the present disclosure is not limited to this. In other embodiments, the second direction in which the main body part extends and the second direction in which the soldering leg extends may be perpendicular to each other or at any angle which is suitable for arrangement.

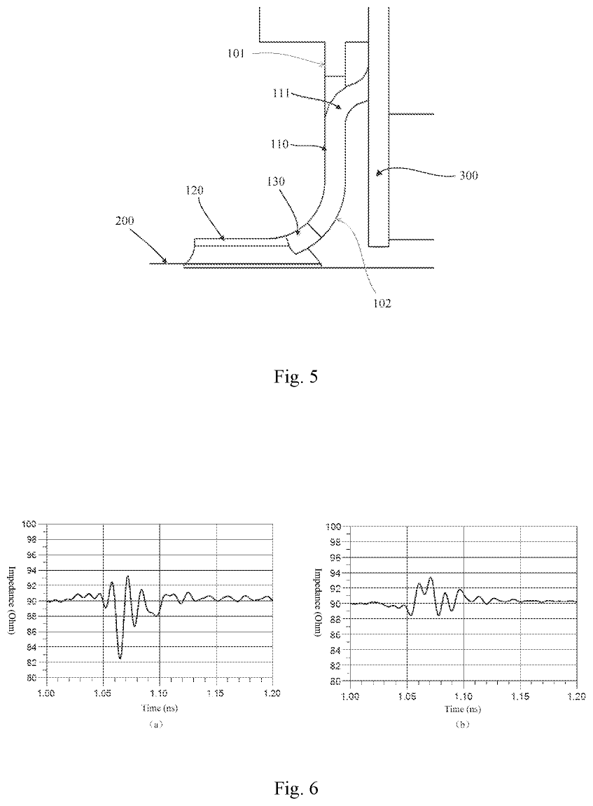

The transition section 130 or its bent section may be an arc-shaped section. As shown in FIGS. 3 and 5, the bending radius is large and slowly changed so as to be easily bent by machining. As an example, the connection terminal having the portion with the gradually changed width may be one-piece or single-piece structure, such as by stamping a plate into one piece.

As shown in FIGS. 3 and 5, the electrical connector may further include a ground shielding plate 300 installed in its insulating housing. The ground shielding plate 300 is connected to all of the ground terminals 102, for example the ground shielding plate and all of the ground terminals are formed unitarily or monolithically as one-piece. As an example, each of the ground terminals 102 extends from the ground shielding plate 300 to be soldered on the soldering pad on the circuit board 200 by the soldering leg 120, thereby providing a signal shielding effect on the signal terminal of the electrical connector. The signal terminal 101 may be separated from the ground shielding plate 300, and the ground terminal 102 extends at least away from the ground shield plate 300 by means of the bent section of the transition section 130. As an example, the main body part 110 of the ground terminal 102 may include a bent portion 111 extending from the ground shielding plate 300, as shown in FIGS. 4 and 5. The bent portion 111 may be bent in different directions from the bent section of the transition section 130, so that at least a portion of the main body part 110 may extend in the first direction (e.g., the vertical direction as shown in the figures) and be positioned between the adjacent signal terminals or aligned with the signal terminal in the width direction to provide signal shielding effect.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property

What is claimed is:

1. A connection terminal for an electrical connector, comprising:
a main body part configured to be installed inside an insulating housing of the electrical connector;
a soldering leg adapted to be soldered on a circuit board so as to electrically connect the connection terminal to the circuit board, the soldering leg and the main body part having different widths; and
a transition section extending from the main body part to the soldering leg, the transition section having a changing width along at least a portion thereof.

2. The connection terminal according to claim 1, wherein the entire transition section is bent and has a changing width.

3. The connection terminal according to claim 1, wherein the transition section comprises a first portion having a width equal to a width of the main body part and a second portion extending from the first portion to the soldering leg, a width the second portion changing between the first portion and the soldering leg.

4. The connection terminal according to claim 1, wherein the connection terminal is a one-piece structure.

5. The connection terminal according to claim 1, wherein the main body part has a first width, the soldering leg has a second width less than the first width, and the width of the at least a portion of the transition section decreases from the first width to the second width.

6. The connection terminal according to claim 5, wherein the entire transition section is bent and has a changing width.

7. The connection terminal according to claim 5, wherein the transition section comprises a first portion having a width equal to a width of the main body part and a second portion extending from the first portion to the soldering leg, a width the second portion changing between the first portion and the soldering leg.

8. The connection terminal according to claim 1, wherein the at least a portion of the transition section is a bent section.

9. The connection terminal according to claim 8, wherein the bent section comprises an arc-shaped section.

10. The connection terminal according to claim 8, wherein the entire transition section is bent and has a changing width.

11. The connection terminal according to claim 8, wherein the transition section comprises a first portion having a width equal to a width of the main body part and a second portion extending from the first portion to the soldering leg, a width the second portion changing between the first portion and the soldering leg.

12. The connection terminal according to claim 8, wherein the main body part extends at least partially in a first direction, and the soldering leg extends in a second direction perpendicular to the first direction.

13. The connection terminal according to claim 12, wherein the bent section is bent from a portion extending in the first direction to a portion extending in the second direction.

14. The connection terminal according to claim 12, wherein the entire transition section is bent and has a changing width.

15. The connection terminal according to claim 12, wherein the transition section comprises a first portion having a width equal to a width of the main body part and a second portion extending from the first portion to the soldering leg, a width the second portion changing between the first portion and the soldering leg.

16. An electrical connector, comprising:
an insulating housing;
a signal terminal arranged in the housing; and
a ground terminal arranged in the housing, at least one of the signal terminal or the ground terminal including:
a main body part;
a soldering leg adapted to be soldered on a circuit board so as to electrically connect the connection terminal to the circuit board, the soldering leg and the main body part having different widths; and
a transition section extending from the main body part to the soldering leg, the transition section having a changing width along at least a portion thereof.

17. The electrical connector according to claim 16, wherein:
the signal terminal and the ground terminal are arranged at an interval in their width direction; and
one or more ground terminals are provided between adjacent signal terminals, or one or more signal terminals are provided between adjacent ground terminals.

18. The electrical connector according to claim 16, wherein the electrical connector further includes a ground shielding plate, the ground terminal extending from the ground shielding plate to the circuit board.

19. The electrical connector according to claim 18, wherein the main body part of the ground terminal includes a bent portion extending from the ground shielding plate.

20. The electrical connector according to claim 16, wherein the electrical connector comprises a high-speed input and output connector.
